(19) United States
(12) Patent Application Publication
(10) Pub. No.: US 2010/0098901 A1
(43) Pub. Date: Apr. 22, 2010

(54) CARPET BACKING COMPOSITION

(76) Inventors: John E. Cowart, Ringgold, GA (US); Roger W. Bergman, Midland, MI (US); Chia-Chen Lo, Raleigh, NC (US); Jason K. Harwood, Chattanooga, TN (US)

Correspondence Address: The Dow Chemical Company, Intellectual Property Section, P.O. Box 1967, Midland, MI, 48641-1967, US

(21) Appl. No.: 12/443,597

(22) PCT Filed: Oct. 5, 2007
(86) PCT No.: PCT/US07/21479

§ 371 Date: Mar. 30, 2009

Related U.S. Application Data
(60) Provisional application No. 60/856,385, filed on Oct. 31, 2006.

(51) Int. Cl. B32B 33/00; C08L 33/08

(52) U.S. Cl. 428/95; 524/561

(57) ABSTRACT

A carpet backing composition comprising: (1) a binding amount of a copolymer binder that is polymerized from a monomer mixture comprising: from 10 to 50 weight parts of a first low T_{g} monomer (A) comprising an alkyl acrylate monomer and, optionally, an additional low T_{g} comonomer; from 50 to 90 weight parts of a second high T_{g} monomer (B) comprising vinyl acetate and, optionally, an additional high T_{g} comonomer; and, optionally, up to 5 parts of a carboxylic acid monomer (C); wherein the total of A, B and C is 100 weight parts monomers; and (2) a filler; with the proviso that the monomer mixture is substantially free of ethylene.

### CROSS-REFERENCE TO PRIOR APPLICATION

This application claims the benefit of U.S. Provisional Application No. 60/856,385 filed Oct. 31, 2006.

### BACKGROUND OF THE INVENTION

The present invention relates to carpet coating compositions that contain a vinyl ester-based emulsion binder.

Most conventional carpets comprise a primary backing with yarn tufts in the form of cut or uncut loops extending upwardly from the backing to form a pile surface. In the case of tufted carpets, the yarn is inserted into a primary backing by tufting needles and then a pre-coat or binder is applied thereto. In the case of non-tufted or bonded pile carpets, the fibers are embedded and actually held in place by the binder composition.

In both cases, the carpet construction usually also includes a secondary backing bonded to the primary backing. The secondary backing can provide extra padding to the carpet, absorb noise, add dimensional stability and often function as a heat insulator. The secondary backing, typically either a foam sheet or a woven fabric, is laminated to the primary backing by a binder or adhesive layer applied to the tuft-lock coated primary backing. Similar techniques are used in the preparation of broadloom carpet as well as carpet tiles.

The physical properties of the binder are important to successful utilization as a carpet backing coating. In this regard, there are a number of important requirements that must be met by such a coating. It must be capable of being applied to the carpet and dried using the processes and equipment conventionally employed in the carpet industry. It must provide excellent adhesion to the pile fibers to secure them firmly to the backing, both in tufted and non-tufted constructions. The coating must also have low smoke density values and high flame retardant properties and must accept a high loading of traditional fillers such as calcium carbonate, aluminum trihydrate, barite and feldspar. Furthermore, the coating must maintain sufficient softness and flexibility, even with high filler loading or at low temperature, to enable the carpet, if prepared in broadloom form, to be easily rolled and unrolled during installation. The softness and flexibility properties will vary depending on the style of carpet but, in all cases, it is important that the carpet will lie flat and not exhibit a tendency to curl or dome.

There is an increasing desire to incorporate recycled content into both broadloom carpet and carpet tiles. There are many initiatives, such as the US Green Building Council's Leadership in Energy and Environmental Design (LEED), which are environmentally driven and promote the use of recycled content in construction products. Recycled materials are being evaluated for fibers in both the backing and the face, as well as for filler in the carpet backing compound to replace calcium carbonate. CFA is a filler that has been evaluated for many years as a recycled filler in carpet backing. While there has been some success in incorporating the CFA in some backing systems like PVC or polyurethane based systems, latex-based systems have exhibited instability to CFA in two ways. The first is an impractical rise in viscosity, usually to the point of gelation, when CFA is incorporated into an latex-containing carpet compound. This gelation generally occurs in the first 24 hours after production. The second way is exhibited by exposing a film of backing compound to the heat age test. When a CFA-containing film is exposed to heat, it can become very brittle within 48 hours and usually within 24 hours. The industry standard for carpet compound is that it must maintain flexibility for 4 days, while most remain flexible for 6 to 8 days.

Some carpet applications require a high degree of water resistance, a requirement that can be met by the use of a plastisol or the addition of hot melt adhesive to the primary and/or secondary backings. The use of a plastisol places a further requirement on the binder utilized in the primary coating, in that the binder must have good adhesion to the plastisol. Furthermore, plastisols contain plasiticizers, such as di-octyl phthalate, that can slowly migrate into the dried carpet coating compound. Plasticizer migration causes carpet physical properties to deteriorate over time. Currently, vinyl acetate ethylene (VAE) latexes are used to coat PVC backed carpet and carpet tiles, but VAE latex is not stable to CFA.

It would be desirable to have a coating composition for use in the manufacture of carpet and carpet tile, such that the coating composition would exhibit excellent stability to recycled fillers, particularly CFA. The stability ideally would be evident both in the measurement of viscosity over time for a carpet compound and through evaluation of the heat age stability of the same compound. It would also be desirable to have a carpet compound that would exhibit excellent adhesion to PVC plastisols and excellent resistance to plasticizer migration, and that could also incorporate recycled fillers such as coal fly ash and ground glass.

### SUMMARY OF THE INVENTION

The invention includes a carpet backing composition comprising:

(1) a binding amount of a copolymer binder that is polymerized from a monomer mixture comprising: from 10 to 50 weight parts of a first low Tg monomer (A) comprising an alkyl acrylate monomer and, optionally, an additional low Tg comonomer; from 50 to 90 weight parts of a second high Tg monomer (B) comprising vinyl acetate and, optionally, an additional high Tg comonomer; and, optionally, up to 5 parts of a carboxylic acid monomer (C); wherein the total of A, B and C is 100 weight parts monomers; and
(2) a filler;
with the proviso that the monomer mixture is substantially free of ethylene. Another aspect of the invention includes carpet products made using the carpet backing composition of the invention.

Surprisingly, the composition of the invention exhibits at least one of the following: good stability to coal fly ash, good adhesion to PVC plastisols, and/or resistance to migration of the plasticizers from PVC plastisols.

### DETAILED DESCRIPTION OF THE INVENTION

The coating composition of the invention comprises a filler and a binder.

For the purposes of the present invention, the term “dry” means in the substantial absence of water and the term “dry basis” refers to the weight of a dry material. For the purposes of the present invention, the term “phr” is well known to those skilled in the art as standing for carts per hundred rubber and means dry parts/hundred dry parts of latex binder.

For the purposes of the present invention, the term “copolymer” means a polymer formed from at least 2 monomers. For the purposes of the present invention, the term “low Tg monomer” means a monomer that, when homopolymerized, gives a homopolymer having a Tg of less than 10° C., and includes mixtures of such monomers. Similarly, the term “high Tg monomer” means a monomer that, when homopolymerized, gives a homopolymer having a Tg of at least 10° C., and includes mixtures of such monomers.

For the purposes of the present invention, the term “(meth)” indicates that the methyl substituted compound is included in the class of compounds modified by that term. For example, the term (meth)acrylic acid represents acrylic acid and methacrylic acid.

The binder employed in the backing compound formulation advantageously comprises a synthetic latex. A synthetic latex, as is well known, is an aqueous dispersion of polymer particles prepared by emulsion polymerization of one or more monomers. For the purposes of the invention, a latex is employed such that the binder has sufficient adhesive properties for use in the manufacture of carpet products. The monomer composition employed in the preparation of the latex comprises from about 10 to 50 pphm of a first monomer (A), from about 50 to 90 pphm of a second monomer (B), and from 0 to about 5 pphm of a carboxylic acid monomer (C), wherein the total of monomers A, B and C is 100 weight parts monomers. As used herein, the term “pphm” means parts per hundred monomer, a term well known to those skilled in the art. Accordingly, the total parts monomer employed is 100 parts monomer, on a weight basis. The Tg of the binder is not particularly critical and can vary based upon the particular application involved. Advantageously, the binder has a Tg of from about −20 to 30° C., preferably from about −10 to about 20° C., and more preferably from about −5 to about 10° C.

The first monomer (A) is a low Tg monomer comprising an alkyl acrylate. Preferably, the alkyl acrylate has from 1 to 10 carbon atoms in the alkyl moiety. Mixtures of first monomers can be employed, e.g. the first monomer (A) can be a mixture of alkyl acrylates, or a mixture of one or more alkyl acrylates with one or more low Tg comonomers. Examples of alkyl acrylates and low Tg comonomers include monomers having a Tg of less than 10° C. that are C₁-C₁₀ alkyl esters of acrylic acid, C₂-C₁₀ alkyl esters of alpha, beta-ethylenically unsaturated C₄-C₆ monocarboxylic acids, C₄-C₁₀ dialkyl esters of alpha, beta-ethylenically unsaturated C₄-C₈ dicarboxylic acids, and vinyl esters of carboxylic acids, including, without limitation, vinyl isobutyrate, vinyl-2-ethyl-hexanoate, vinyl isooctanoate, vinyl versatate (vinyl neodecanoate), and mixtures of branched vinyl esters, such as the commercially available VeoVa 11 and EXXAR Neo-12. Preferably, the low Tg monomer is selected from the group consisting of C₁-C₁₀ alkyl esters of (meth)acrylic acid, i.e. alkyl (meth)acrylates, and C₄-C₈ dialkyl esters of maleic, itaconic and fumaric acids. Preferably, at least one C₂-C₈ alkyl ester of acrylic acid is utilized. Particularly preferred low Tg monomers include ethyl acrylate, butyl acrylate, 2-ethyl hexyl acrylate, decyl acrylate, dibutyl maleate and dioctyl maleate, with butyl acrylate being most preferred. The first monomer (A) advantageously is used in amounts of from about 10 pphm to about 50 pphm, preferably 15 pphm to 40 pphm. In one embodiment of the invention, the amount of alkyl acrylate is greater than the amount of the optional low Tg monomer. Advantageously, the amount of optional low Tg monomer employed is from about 0 to about 10 weight percent, based on the total weight of monomer (A).

The second monomer (B) is a high Tg monomer comprising vinyl acetate. Mixtures of second monomers can be employed, e.g. the second monomer (B) can be a mixture of vinyl acetate with one or more high Tg comonomers. Optionally, part of the vinyl acetate utilized to prepare the binders herein can be substituted with up to 20 pphm of one or more high Tg comonomers having a Tg greater than 10° C. such as, for example, vinyl esters of carboxylic acids, the acid having from two to about 13 carbon atoms. Representative optionally employed high Tg comonomers include methyl methacrylate, dimethyl maleate, t-butyl methacrylate, t-butyl isobornyl acrylate, phenyl methacrylate, acrylonitrile and vinyl esters of carboxylic acids having Tg of at least 10° C. Examples of such vinyl esters include vinyl pivalate, vinyl neononanoate, and vinyl propionate. When the optional high Tg comonomer is used it is preferably present at less than 15 pphm and more preferably less than 10 pphm. The second monomer (B) advantageously is employed in an amount of from about 50 pphm to about 90 pphm, preferably 60 pphm to 85 pphm.

The binder polymer is essentially free of polymerized ethylene.

It may also be desired to incorporate in the binder polymer minor amounts of one or more functional comonomers (C). Suitable copolymerizable comonomers (C) include, for example: carboxylic acid monomers such as acrylic acid, methacrylic acid, itaconic acid, fumaric acid, and the half esters of maleic acid, such as monoethyl, monobutyl or monooctyl maleate; acrylamide; tertiary octylacrylamide; N-methylol(meth)acrylamide; N-vinylpyrrolidinone; diallyl adipate; triallyl cyanurate; butanediol diacrylate; allyl methacrylate; etc.; as well as C₂ -C₃ hydroxyalkyl esters such as hydroxyethyl acrylate, hydroxy propyl acrylate and corresponding methacrylates. The comonomer (C) generally is used at levels of less than 5 pphm, preferably less than 2.5 pphm and more preferably less than 1 pphm, depending upon the nature of the specific comonomer. Mixtures of comonomer (C) can be employed.

In addition, certain copolymerizable monomers that assist in the stability of the binder, e.g., vinyl sulfonic acid, sodium vinyl sulfonate, sodium styrene sulfonate, sodium allyl ether sulfate, sodium 2-acrylamide-2-methyl-propane sulfonate (AMPS), 2-sulfoethyl methacrylate, and 2-sulfopropyl methacrylate, can be employed as emulsion stabilizers. These optional monomers, if employed, are added in very low amounts of from 0.1 pphm to about 2 pphm.

Methods for preparing synthetic latexes are well known in the art and any of these procedures can be used.

Suitable free radical polymerization initiators are the initiators known to promote emulsion polymerization and include water-soluble oxidizing agents, such as, organic peroxides (e.g., t-butyl hydroperoxide, cumene hydroperoxide, etc.), inorganic oxidizing agents (e.g., hydrogen peroxide, potassium persulfate, sodium persulfate, ammonium persulfate, etc.) and those initiators that are activated in the water phase by a water-soluble reducing agent. Such initiators are employed in an amount sufficient to cause polymerization. As a general rule, a sufficient amount is from about 0.1 to about 5 pphm.

Alternatively, redox initiators may be employed, especially when polymerization is carried out at lower temperatures. For example, reducing agents may be used in addition to the persulfate and peroxide initiators mentioned above. Typical reducing agents include, but are not limited to: alkali metal salts of hydrosulfites, sulfoxylates, thiosulfates, sulfites, bisulfites, reducing sugars such as glucose, sorbose, ascorbic acid, erythorbic acid, and the like. In general, the reducing agents are used at levels from about 0.01 pphm to about 5 pphm.

The emulsifying agents are those generally used in emulsion polymerization. The emulsifiers can be anionic, cationic, surface-active compounds or mixtures thereof.

Suitable nonionic emulsifiers include polyoxyethylene condensates. Exemplary polyoxyethylene condensates that can be used include polyoxyethylene aliphatic ethers, such as polyoxyethylene lauryl ether and polyoxyethylene oleyl ether; polyoxyethylene alkaryl ethers, such as polyoxyethylene nonylphenol ether and polyoxyethylene octylphenol ether; polyoxyethylene esters of higher fatty acids, such as polyoxyethylene laurate and polyoxyethylene oleate, as well as condensates of ethylene oxide with resin acids and tall oil acids; polyoxyethylene amide and amine condensates such as N-polyoxyethylene lauramide, and N-lauryl-N-polyoxyethylene amine and the like; and polyoxyethylene thio-ethers such as polyoxyethylene n-dodecyl thio-ether.

Nonionic emulsifying agents that can be used also include a series of surface active agents available from BASF under the PLURONIC and TETRONIC trade names. In addition, a series of ethylene oxide adducts of acetylenic glycols, sold commercially by Air Products under the SURFYNOL trade name, are suitable as nonionic emulsifiers.

Representative anionic emulsifiers include the alkyl aryl sulfonates, alkali metal alkyl sulfates, the sulfonated alkyl esters, and fatty acid soaps. Specific examples include sodium dodecylbenzene sulfonate, sodium butylnaphthalene sulfonate, sodium lauryl sulfate, disodium dodecyl diphenyl ether disulfonate, N-octadecyl sulfosuccinate and dioctyl sodiumsulfosuccinate. The emulsifiers are employed in amounts effective to achieve adequate emulsification of the polymer in the aqueous phase and to provide desired particle size and particle size distribution.

Other ingredients known in the art to be useful for various specific purposes in emulsion polymerization, such as, acids, salts, chain transfer agents, chelating agents, buffering agents, neutralizing agents, defoamers and plasticizers also may be employed in the preparation of the polymer. For example, if the polymerizable constituents include a monoethylenically unsaturated carboxylic acid monomer, polymerization under acidic conditions (pH 2 to 7, preferably 2 to 5) is preferred. In such instances the aqueous medium can include those known weak acids and their salts that are commonly used to provide a buffered system at the desired pH range.

Various protective colloids may also be used in place of or in addition to the emulsifiers described above. Suitable colloids include casein, hydroxyethyl starch, carboxyxethyl cellulose, carboxymethyl cellulose, hydroxyethylcellulose, gum arabic, alginate, poly(vinyl alcohol), polyacrylates, polymethacrylates, styrene-maleic anhydride copolymers, polyvinylpyrrolidones, polyacrylamides, polyethers, and the like, as known in the art of emulsion polymerization technology. In general, when used, these colloids are used at levels of 0.05 to 10% by weight based on the total weight of the reactor contents.

The manner of combining the polymerization ingredients can be by various known monomer feed methods, such as, continuous monomer addition, incremental monomer addition, or addition in a single charge of the entire amounts of monomers. The entire amount of the aqueous medium with polymerization additives can be present in the polymerization vessel before introduction of the monomers, or alternatively, the aqueous medium, or a portion of it, can be added continuously or incrementally during the course of the polymerization.

Following polymerization, the solids content of the resulting aqueous polymer binder dispersion can be adjusted to the level desired by the addition of water or by the removal of water by distillation. Generally, the desired level of binder solids content is from about 40 weight percent to about 75 weight percent based on the total weight of the binder, more preferably from about 50 weight percent to about 70 weight percent.

The filler employed can be essentially any filler suitable for use in carpet manufacture. Such fillers are widely commercially available. Examples of mineral fillers or pigments include fly ash and ground glass and those known in the art, such as calcium carbonate, clay, kaolin, talc, barites, feldspar, titanium dioxide, calcium aluminum pigments, satin white, synthetic polymer pigment, zinc oxide, barium sulphate, gypsum, silica, alumina trihydrate, mica, hollow polymer pigments, and diatomaceous earth. Mixtures of fillers can be employed.

While the filler employed is not particularly critical, one advantage of the binder of the invention is that it exhibits surprisingly good compatibility with coal fly ash. The coal fly ash employed in the present invention is a well-known material and is generally available as a waste by-product of large scale coal fueled power generation plants. The chemical composition of coal fly ash is dependent upon the coal source, how the coal was burned, and the collection method. The chemical composition of coal fly ash generally comprises a major portion of SiO₂, Al₂O₃, and Fe₂O₃ and a minor portion of CaO, MgO, Na₂O, K₂O, SO₃, and TiO₂. The preferred coal fly ash material employed in this invention is categorized as “Class F” fly ash pursuant to ASTM Standard C618-05. This fly ash is normally produced from burning anthracite or bituminous coal that meets the applicable requirements for Class F fly ash given in C618-05. In one embodiment of the invention, the filler is essentially free of Class C fly ash.

The amount of filler that is employed can vary depending upon the density of the filler and the coating properties desired. The amount of filler employed in the composition of the invention advantageously is from about 50 to about 800 phr and preferably is from about 100 to about 600 phr. In one embodiment of the invention, part or all of the filler can be coal fly ash. When less than about 350 phr filler is employed, the filler can be entirely coal fly ash. Advantageously, the filler comprises from about 100 to about 600 phr coal fly ash, and preferably is from about 150 to about 350 phr coal fly ash.

In one embodiment of the invention, carpet coating compositions can contain 11 to 67 percent by weight of the binder and 33 to 89 percent by weight of filler, based on the total weight of binder and filler. Preferably, the carpet coating compositions contain 14 to 50 percent by weight of the binder and 50 to 86 percent by weight of filler.

If desired, conventional additives may be incorporated into the carpet backing compound of the invention in order to modify the properties thereof. Examples of these additives include thickeners, catalysts, dispersants, colorants, biocides, anti-foaming agents, and the like.

The coating composition of the present invention advantageously can be used in the production of conventional tufted carpet, non-tufted carpet and needle-punched carpet and can be dried using equipment that is well known to those skilled in the art, such as that used in carpet mills. Thus, the coating composition is useful in the production of pile carpets comprising a primary backing with pile yarns extending from the primary backing to form pile tufts; as well as non-tufted carpets wherein the fibers are embedded into the binder composition that has been coated onto a woven or non-woven substrate.

The coating composition is employed in the manufacture of carpet according to techniques well known to those skilled in the art. The coating composition is advantageously employed in the manufacture of PVC-backed carpet tile in view of its superior resistance to plasticizer migration.

In preparing a tufted carpet, the yarn is tufted or needled into a primary backing, which is generally non-woven polypropylene, polyethylene or polyester or woven jute or polypropylene. If a secondary backing is used, it is generally formed of woven or non-woven materials similar to those used as the primary backing and applied directly to the wet pre-coated primary backing prior to the drying step or applied with a separate adhesive to the dried pre-coated primary backing. Such a secondary backing provides dimensional stability to the carpet. The secondary backing can be in the form of a foam polymer or copolymer. Suitable foam compositions include urethane polymers, polymers and copolymers of vinyl chloride, and polymers and copolymers of ethylene, propylene, and isobutylene. When a foam secondary backing is used, it can be prefoamed and then laminated onto the primary backing, or the composition can contain a thermally activatable blowing agent and can be foamed immediately prior to lamination or after lamination. Additionally, the secondary backing can exhibit thermoplastic adhesive properties of its own, and the secondary backing can be preheated prior to lamination to render the surface thereof adhesive. Alternatively, the secondary backing can comprise a hot melt, one or more fused PVC plastisol layer(s) or bitumen, often in conjunction with fiberglass scrim or other scrim known to provide dimensional stability. It is also contemplated that the coating composition disclosed herein for use as the primary backing can be used as the secondary backing.

In forming a non-tufted carpet, the carpet coating composition is generally thickened to a viscosity of about 2,000 to 75,000 cP and applied to a scrim surface. The fibers then are directly embedded into the wet coating using conventional techniques and then dried. Again, a secondary coating similar to that described above is desirably employed.

The coating composition of the invention is easier to apply to the carpet than hot melt thermoplastic adhesives that require expensive and complex machines and processes to apply the coating, and the coating also penetrates the fibers of the carpet yarns to yield better adhesion, fiber bundle integrity and anti-fuzzing properties. The term “tuft-bind” refers to the ability of the carpet coating to lock and secure the pile yarn tufts to the primary backing and is determined as set forth hereinbelow. Tuft-bind is also used to include the superior characteristics needed in non-tufted coatings wherein the adhesion of the fiber pile is achieved solely by the backing. Suitable tuft-bind properties can be achieved by applying an amount of coating composition ranging from about 10 ounces per square yard to about 40 ounces per square yard (dry basis), which results in a carpet having a tuft-bind value of at least 10 pounds force, and in many instances a tuft-bind value of 15 pounds force or greater.

The present invention also provides a method of preparing a pile or tufted carpet that includes the steps of;

a) tufting or needling the yarn into a woven or non-woven backing;

b) applying the carpet coating composition of the present invention to the rear of the backing such that the yarn is embedded in the carpet coating; and

c) drying the resultant carpet construction.

In producing such tufted carpets it is also desirable to apply a secondary backing to the primary backing either before or after drying of the carpet coating, depending upon the type of backing employed.

Non-tufted carpets also can be prepared utilizing the carpet coating compositions of the invention by a method that comprises the steps of:

a) coating the composition of the present invention onto a substrate;

b) embedding the carpet fibers in the substrate; and

c) drying the resultant carpet construction.

These non-tufted carpets also can be advantageously prepared utilizing a secondary backing to provide additional dimensional stability.

Carpet prepared using the backing composition of this invention advantageously can contain recycled content that results in a more environmentally friendly product. This environmentally friendly carpet makes it easier for specifiers and architects to meet the criteria set forth in various environmentally focused purchasing criteria such as the US Green Building Council's LEED program. This invention also allows the flexibility of use for PVC backed carpet tiles or PVC backed broadloom carpet due to the excellent plasticizer migration resistance of the carpet backing compound.

### Specific Embodiments of the Invention

The following examples are given to illustrate the invention and should not be construed as limiting in scope. All parts and percentages are by weight unless otherwise indicated.

The following materials are used in the coating compositions:
Filler (A): dry calcium carbonate that consists of a particle size allowing 65% to pass through a 200 mesh screen (65-200 available from Duvall Chemicals in Dalton, Ga.).
Filler (B): Class F Coal Fly Ash (PV 14A available from Boral Industries, Sydney, Australia).
Latex (A): carboxylated styrene-butadiene latex (LXC 8476NA available from The Dow Chemical Company, Midland, Mich., USA), 52% solids in water.
Latex (B): carboxylated vinyl acrylic latex (UCAR 162 available from The Dow Chemical Company, Midland, Mich., USA), 55% solids in water.
Latex (C): vinyl acetate ethylene latex (TX 848 available from National Starch) 63% solids in water.
Latex (D): carboxylated styrene-butadiene latex (LXC 811NA available from The Dow Chemical Company, Midland, Mich., USA), 56% solids in water.
Froth Aid (A): proprietary blended froth aid containing sodium lauryl sulfate and lauryl alcohol (STANFAX 561 available from ParaChem, Simpsonville, S.C.).
Froth Aid (B): proprietary blended froth aid containing sodium lauryl sulfate and lauryl alcohol (CHEMFROTH 2209 available from ChemTex, Charlotte, N.C.).
Penetrant (A): proprietary penetrant (CHEMWET 1396B from ChemTex, Charlotte, N.C.).
Thickener (A): proprietary sodium polyacrylate thickener (CHEMTHIC 102, ChemTex, Charlotte, N.C.).

Carpet Sample Preparation

To prepare carpet samples, carpet greige samples are cut to an appropriate size dependent on the amount of material available and required test specimens. An 18″ long×13½″ wide piece of carpet greige is typical. Comparably sized pieces of secondary backing are also cut. The carpet greige to be coated is then placed face down on a rigid backing plate and the bottom edge of the sample is positioned near the edge of a lab bench above a trash can so that the excess coating compound can be dropped into the trash can. Weights are positioned on the top edge of the sample and a clamp on the bottom to hold the sample in position during the coating. The test compound is then frothed to an appropriate ratio of air to compound, typically ranging from 0% to 70% air, using a Hobart mixer. A free turning metal applicator (doctor) roll, 1⅛″ diameter×11″ long, fitted with metal dams and weighing approximately 1510 grams is used. The applicator roller is placed at the top edge of the greige sample and the frothed or non frothed compound is poured just below the roller. Without adding any additional down force and at a uniform rate, the coater/roller assembly is pulled forward (toward the bottom edge of the sample) to spread the compound evenly over the length of the sample. The coater/roller is then turned over and excess compound is rolled to the top of the sample. The coater/roller is turned over again, the bottom clamp is removed, then the roller is dragged down the sample (with same force not letting roller turn) letting excess coating composition fall into the trash can.

The coating compound is applied with a 30 mil drawdown bar to a glass plate. The scrim is laid napped side down on the wet surface. A metal marriage roll (1¾″ diameter×11″ long) with an approximate weight of 3400 grams is applied to the scrim for one pass. The scrim is lifted from the glass plate and immediately aligned over the wet (freshly coated) area of the greige goods and positioned under the hold down weight at the samples top edge. The marriage roll is placed at the top edge of the sample and, with no additional down force, rolled down the length of the sample at a uniform rate in a single direction for one pass. The carpet sample is immediately placed in an oven at 270-275° F. (132-135° C.) for 8 minutes with the tufted side of the sample down. To avoid premature flexing of the carpet sample during the coating process as well as during the transport of the sample to the drying oven, the sample to be coated is to be positioned on a rigid support sheet (glass) that is removed after placing the sample into the oven.

Test Methods

The following test procedures are used to evaluate carpet coating compositions of the present invention.

Brookfield Viscosity—The viscosity is measured at room temperature using a Brookfield RVT viscometer (available from Brookfield Engineering Laboratories, Inc., Stoughton, Mass., USA). Speed and spindle type are indicated with the corresponding data.

Tuft bind—The tuft bind is measured to determine how well the yarn is being held into the primary of a tufted carpet and is performed according to ASTM D1335, except that lab prepared test samples are 3 in×9 in (7.6 cm×22.9 cm) and are cut from a 9 in×9 in (22.9 cm×22.9 cm) coated sample. Three test samples are cut from each coated sample and 3 tufts are pulled from each test sample for a total of 9 pulls per coated sample.

Dry Delamination Strength—Delamination Strength is measured to determine the strength of the bond between the latex compound and both the secondary backing and carpet greige goods. This method is performed according to ASTM D3936 except that lab prepared samples are 3 in×9 in (7.6 cm×22.9 cm) and are cut from a 9 in×9 in (22.9 cm×22.9 cm) coated sample. Since the test is run in triplicate, the entire 9 in×9 in original sample is cut up and used and the ASTM requirement of cutting samples at least 5% of the total width from the edge is not followed.

Wet Delamination Strength—The wet delamination strength is measured to determine how well carpet retains its delamination strength after it has been rewet. Carpet is submerged in water for 20 minutes, drained, blotted with a paper towel and pulled for delamination according to the method of the Dry Delamination Strength test mentioned above.

Hand—This test measures the flexibility of a finished carpet sample by determining the pounds of force required to deflect the carpet sample 0.5 inches (1.3 cm). The carpet sample (9×9-in. (22.9 cm×22.9 cm) or 9×12-in (22.9 cm×30.5 cm) is allowed to equilibrate for a minimum of two hours under the desired test conditions. “Normal” conditions are 50% (±5%) relative humidity and 72° F. (±5° F.) (22.2° C.) temperature. The test is run by placing a carpet sample face up on a 5.5 inch (13.97 cm) inside diameter hollow cylinder mounted in the bottom fixture of an Instron. A 2.25″ (5.71 cm) outside diameter solid foot, mounted in the top jaw, is lowered to the face of the carpet until the exerted force registers 0.05 to 0.10-lbs of deflective force, and this is the starting position. The Instron is configured with a Crosshead travel of 0.65-in and the speed of travel=12.0 in/min, and the foot is driven into the carpet sample. The force needed to deflect the carpet sample 0.5 inches is measured. The sample is then turned over so the face of the carpet is down. The foot is lowered again and another measurement is taken. This process is repeated until 4 measurements are recorded. These measurements are averaged and the average is reported as the Hand of the carpet.

Heat Age—Heat age testing is performed on carpet coating compounds to indicate the effect of oxidation on embrittlement of dried compound. Through the use of elevated temperatures and increased air flow, polymer oxidation rates are accelerated and monitored by color change and flexibility testing. Carpet coating compounds are tested by placing a glass plate on the table where the edge of the plate is over the edge of the table. A container is then placed under the edge of the glass plate to catch the excess latex compound. A 40 mil draw down bar is placed at the top of a Teflon coated plate. Then latex compound is poured in front of the draw down bar with enough compound to cover an inch in width in front of the bar. The bar is then slowly pulled down the length of the plate, and excess compound is wiped off. The coated plate is placed into a ventilated box to air dry overnight. Once the sample is dry, it is removed from the plate and a 1″ strip is cut from the sample as a control or “0 day” specimen. Secure each sample at the top with two tongue depressors (one on either side) and binder clips and hang them from a carousel in a convection oven that is set at 135±2° C. (275±3.5° F.). Turn the carousel on to a slow speed. Every 24 hours, turn off the carousel and remove the sample and cut a 1″ (2.54 cm) strip from the film. The strip is labeled with sample identification and the number of days of exposure. With the sample at room temperature, gently flex it to determine whether it has reached the point of brittle failure. When the specimen snaps like a potato chip, or cannot be bent without breaking, it has failed. Report the number of days the film passes the test. Four days currently generally is considered the minimum acceptable performance for heat age in the carpet industry.

Plasticized Tuft Bind—The plasticized tuft bind is measured to determine how well the tuft bind strength is maintained after exposure to plasticizers such as di-octyl phalate and di-isononyl phthalate. These plasticizers are present in plastisols such as PVC plastisols and are prone to migration into dried carpet compounds. The test is performed by coating and drying a 9 inch×9 inch (22.9 cm×22.9 cm) sample of carpet with coating compound. Cut the sample in half leaving two 9 inch×4.5 inch (22.9 cm×11.4 cm) pieces. One of these pieces is used as the control. To the other piece, apply 3.1 ounces per square yard (105.2 g/m²) of di-isononylphthalate (DINP) to the back of the coated greige and place in an oven at 180° F. (82.2° C.) for 2 hours. DINP is applied using a 4 inch velour paint roller and tray. The 9 inch×4.5 inch coated greige is placed on a Mettler balance and the DINP is rolled evenly onto the back of the carpet until the balance indicates that 3.5 grams has been applied. The carpet is then reconditioned and tested using the tuft bind test method described hereinabove to determine the tuft bind value. The tuft bind values before treating (control) with DINP and after treating with DINP are compared. The tuft bind values are reported.

Coating Compound Preparation

Binders are formulated into the carpet coating formulations set forth in Table 1 and identified as F1, F2 and F3. Carpet samples are prepared and each coating is evaluated for end use properties as identified in Tables 2-5. The data tables from each example identify which binder and which filler are used in each sample, as well as the thickener level and compound viscosity.

TABLE 1
Carpet Coating Formulations
(Expressed in phr (dry parts/hundred dry parts of latex binder))

| Description | F1 | F2 | F3 |
|---|---|---|---|
| Binder | 100 | 100 | 100 |
| Filler | 350 | 185 | 185 |
| Froth Aid (A) | 2.0 | 0 | 0.66 |
| Froth Aid (B) | 0 | 0.8 | 0 |
| Penetrant | 0.3 | 0.3 | 0.3 |
| Thickener | 0.34-0.73 | 0.27-1.34 | 0.3-1.3 |
| Viscosity - cP | 8300-9300 | 3000-4000 | 3000-4000 |
| (#5 @ 20 rpm) | | | |
| Compound Solids - (%) | 82.0 | 74.25 | 77.2 |

### Example 1

Formulation F1 is used for this example. Three versions of F1 are made and identified as F1-1, F1-2 and F1-3, as follows:

| | Compound # | | |
|---|---|---|---|
| | F1-1 | F1-2 | F1-3 |
| Latex | B | B | D |
| Filler | A | B | A |
| Thickener | 0.34 | 0.73 | 0.46 |
| (phr) | | | |

Viscosity build refers to the increase of the viscosity of a carpet backing compound over time. The viscosity build data along with initial viscosity using both a #5 and #6 spindles at 20 rpm on an RV type Brookfield viscometer can be found in Table 2. Compounds are typically made to a #5 spindle in carpet mills but viscosity build is measured with a #6 spindle to account for viscosity going above 20,000 cP over time, since 20,000 cP is 100% of scale for a #5 spindle. For this reason, it is helpful to generate an initial viscosity using a #6 spindle for comparison to the build data.

TABLE 2
Viscosity Build Data expressed in centipoise (cP)

| | F1-1 | F1-2 | F1-3 |
|---|---|---|---|
| | VA with | VA with | S/B with |
| Property | CaCO3 | CFA | CaCO3 |
| Initial viscosity (#5 @ 20 rpm) | 8,520 | 8,580 | 8,760 |
| Initial viscosity (#6 @ 20 rpm) | 9,300 | 9,550 | 9,700 |
| 1 day Viscosity Build (#6 @ 20 rpm) | 19,600 | 14,950 | 14,850 |
| 3 day Viscosity Build (#6 @ 20 rpm) | 24,550 | 15,250 | 17,200 |
| 5 day Viscosity Build (#6 @ 20 rpm) | 27,700 | 14,550 | 18,350 |
| Reshear Viscosity (#6 @ 20 rpm) | 14,750 | 9,300 | 8,600 |

This data shows that the viscosity build of a VA latex with CFA is well within the normal range compared to a compound, made with a styrene/butadiene latex and CaCO₃, typically used in the carpet industry. This is surprising because latexes typically used in the carpet industry build in viscosity to an unacceptable and unusable level when compounded with class F CFA.

While it is very desirable, environmentally speaking, to have a compound with stable viscosity that contains CFA, it is important to demonstrate that the compound is useful as a carpet coating precoat and adhesive. Each of the 3 compounds evaluated for viscosity stability are coated on a loop nylon carpet greige at a froth cup weight of approximately 60% air. The finished piece of carpet is allowed to condition in a controlled temperature and humidity lab for 24 hours prior to testing the carpet physicals. A description of the carpet physical data relative to a control S/B compound can be found in Table 3.

TABLE 3
Carpet Physicals

| | | | Delamination | Wet Delamination |
|---|---|---|---|---|
| Compound Description | Hand (lb.) | Tuft bind (lb.) | (lb./in.) | (lb./in.) |
| F1-1: VA with CaCO₃ | 31.0 +/− 4.0 | 7.9 +/− 1.7 | 4.0 +/− .4 | 1.5 +/− .4 |
| F1-2: VA with CFA | 36.7 +/− 5.3 | 9.8 +/− 1.4 | 5.8 +/− .6 | 2.2 +/− .2 |
| F1-3: S/B with CaCO₃ | 30.8 +/− 3.8 | 10.8 +/− 2.6 | 4.3 +/− .6 | 2.1 +/− .4 |
| (Control) | | | | |

Example 1 demonstrates that compounds made with Latex B, carboxylated vinyl acrylic latex (VA) based latex are stable to coal fly ash (CFA) relative to viscosity build, and generate carpet physical data that is comparable to a control compound made with Latex A, a styrene butadiene (SB) latex, in the same formulation.

The data in Table 3 demonstrates that compounds made with VA and either CFA or CaCO₃ are suitable for use as carpet backing compound. Compounds made with CFA actually show improved delamination strength when compared to a control compound with S/B latex and CaCO₃ at equal filler load.

### Example 2

This example demonstrates the heat age resistance of a VA copolymer. In addition to viscosity stability, another issue that has prevented the use of CFA with latex based compounds for carpet in the past is heat age. While compounding an S/B latex using CFA is difficult, compounds can be generated at low loading long enough to make films for heat age testing. A study is conducted to compare the heat age stability of typical S/B latex with CFA in carpet compound against the VA (Latex B) with CFA in carpet compound using compound formulation F2. Two versions of F2 are made and identified as F2-1 and F2-2, as follows:

Compound #

| | F2-1 | F2-2 |
|---|---|---|
| Latex | B | D |
| Filler | B | B |
| Thickener (phr) | 1.34 | 0.27 |

The results of the heat age testing are shown below in Table 4. After 10 days the testing is discontinued on the VA sample.

TABLE 4
Heat Age Results

| Sample Description | Days Passing |
|---|---|
| F2-1: VA | 10+ |
| F2-2: S/B (Control) | 1 |

The data in Table 4 demonstrates the superior heat age resistance of VA polymers even in the presence of CFA filler.

### Example 3

### Resistance to Plasticizer Migration

Two versions of F3 are made and identified as F3-1 and F3-2, as follows:

Compound #

| | F3-1 | F3-2 |
|---|---|---|
| Latex | B | C |
| Filler | A | A |
| Thickener (phr) | 0.02 | 0.02 |

Carpet samples are prepared as described above except that they are prepared as a unitary with no backing applied. The data in table 5 shows the results of this study.

TABLE 5
185 Load Tile Precoat Results vs. VAE Latex

| | Tuft bind | | Plasticized | % Retention of |
|---|---|---|---|---|
| Sample Description | (TB) | Wet TB | TB | Plasticized TB |
| F3-1: VA | 10.0 | 4.9 | 6.2 | 62 |
| F3-2: VAE (Control) | 9.5 | 4.6 | 3.7 | 40 |

The results in this example show the superior plasticizer resistance of Sample F3-1 compared to the control made with VAE latex (F3-2). VAE latexes are currently the commercial standard used for PVC backed tile and broadloom because of their plasticizer migration properties.

1. A carpet backing composition comprising:
(1) a binding amount of a copolymer binder that is polymerized from a monomer mixture comprising: from 10 to 50 weight parts of a first low Tg monomer (A) comprising an alkyl acrylate monomer and, optionally, an additional low Tg comonomer; from 50 to 90 weight parts of a second high Tg monomer (B) comprising vinyl acetate and, optionally, an additional high Tg comonomer; and, optionally, up to 5 parts of a carboxylic acid monomer (C); wherein the total of A, B and C is 100 weight parts monomers; and
(2) a filler comprising at least one of ground glass and Class F fly ash;
with the proviso that the monomer mixture is substantially free of ethylene.

2. The composition of claim 1 comprising 100 dry weight parts binder and from about 100 to about 600 dry weight parts filler.

3. The composition of claim 1 wherein the alkyl acrylate monomer has a Tg of less than 0° C.

4. The composition of claim 1 wherein the monomer mixture comprises butyl acrylate and vinyl acetate.

5. The composition of claim 1 wherein the amount of carboxylic acid monomer is from 0.1 to 5 parts.

6. The composition of claim 1 wherein the filler comprises Class F fly ash.

7. The composition of claim 1 wherein the filler comprises ground glass.

8. A carpet product prepared using the backing composition of claim 1.

9. A carpet coating composition comprising: (1) a binding amount of a copolymer having a Tg of from −20 to 30° C.; and (2) Class F fly ash as filler.
